(19) United States
(12) Patent Application Publication
(10) Pub. No.: US 2022/0230110 A1
(43) Pub. Date: Jul. 21, 2022

(54) VEHICLE ALLOCATION SYSTEM AND VEHICLE ALLOCATION METHOD

(71) Applicant: HONDA MOTOR CO., LTD., Tokyo (JP)

(72) Inventors: Tomohiro Tsukamoto, Wako-shi, Saitama (JP); Kaoru Toba, Wako-shi, Saitama (JP)

(21) Appl. No.: 17/430,477

(22) PCT Filed: Feb. 19, 2019
(86) PCT No.: PCT/JP2019/006141

§ 371 Date: Aug. 12, 2021

(51) Int. Cl. G06Q 10/06; G06Q 50/30; G01C 21/34; G01C 21/36

(52) U.S. Cl. CPC G06Q 10/06315; G06Q 50/30; G01C 21/3697; G01C 21/3423; G01C 21/3415

(57) ABSTRACT

A vehicle allocation plan creation unit recognizes a schedule of a first user in a schedule of the first user acquired by the schedule acquisition unit and creates a vehicle allocation plan for a target vehicle on the basis of the schedule. A travel plan change recognition unit recognizes a change of the travel plan of the first user, the change potentially occurring between when the vehicle allocation plan is created and when the first user starts using the target vehicle. A vehicle allocation plan change unit changes the vehicle allocation plan on the basis of the change of the travel plan of the first user when the travel plan change recognition unit recognizes the change of the travel plan of the first user.

### TECHNICAL FIELD

The present invention relates to a vehicle allocation system and a vehicle allocation method.

### BACKGROUND ART

Vehicle reservation applications have been conventionally proposed that determine whether it is necessary to reserve a vehicle for a user of a vehicle allocation service on the basis of at least one of information on the user's life habit and information on the user's plan to go out and, when it is determined that a vehicle reservation is needed, a vehicle is automatically reserved (see Patent Literature 1, for example).

The vehicle reservation application automatically reserves a vehicle when it is determined that a user cannot reach a destination within a time period from a planned departure time to a planned target time (a planned time of arrival at the destination) of the user.

### CITATION LIST

### Patent Literature

[Patent Literature 1]

Japanese Translation of PCT International Application Publication No. 2018-504724

### SUMMARY OF INVENTION

### Technical Problem

When a vehicle is reserved based on a schedule of a user such as the user's life information and information on plans to go out as in the case of the conventional vehicle reservation application described above, the user's schedule may be changed just before the time for which the vehicle is reserved. Such a last-minute change made to the user's schedule causes problems that the vehicle that has been allocated becomes useless and that the utilization rate of the allocated target vehicle will decrease.

The present invention has been achieved in view of the background described above and has an object of providing a vehicle allocation system and a vehicle allocation method that are capable of inhibiting decrease of the utilization rate of an allocated target vehicle when the vehicle allocation is planned based on a schedule of a user.

### Solution to Problem

In an aspect to achieve the object described above, provided is a vehicle allocation system including: a schedule acquisition unit that acquires a schedule of a first user who uses a vehicle allocation service; a vehicle allocation plan creation unit that recognizes a travel plan of the first user in the schedule and creates a vehicle allocation plan for a target vehicle to be allocated for the first user, the vehicle allocation plan being created based on the travel plan; a vehicle allocation processing unit that executes processing for allocating the target vehicle for the first user, the target vehicle being allocated based on the vehicle allocation plan; a travel plan change recognition unit that recognizes a change of the travel plan of the first user, the change potentially occurring between when the vehicle allocation plan is created and when the first user starts using the target vehicle; and a vehicle allocation plan change unit that changes the vehicle allocation plan when the travel plan change recognition unit recognizes the change of the travel plan of the first user, the vehicle allocation plan being changed based on the change of the travel plan of the first user.

The vehicle allocation system described above may be configured such that the schedule acquisition unit continues to acquire the schedule at a predefined timing after the vehicle allocation plan is created by the vehicle allocation plan creation unit, and the travel plan change recognition unit recognizes the change of the travel plan of the first user, the change being recognized based on the schedule acquired by the schedule acquisition unit after the vehicle allocation plan is created by the vehicle allocation plan creation unit.

The vehicle allocation system described above may be configured such that the vehicle allocation plan creation unit recognizes a planned use start location and a planned use start time that are for the first user to start using the target vehicle and creates the vehicle allocation plan by including an act of waiting by the target vehicle, the planned use start location and the planned use start time being recognized based on the travel plan, the act of waiting being for the target vehicle to be caused to wait at the planned use start location for a predefined waiting time period at maximum from a wait start time that is based on the planned use start time, and the vehicle allocation plan change unit changes an execution condition of the act of waiting by the target vehicle in the vehicle allocation plan when the travel plan change recognition unit recognizes the change of the travel plan of the first user, the execution condition of the act of waiting by the target vehicle being changed based on the change of the travel plan of the first user.

The vehicle allocation system described above may be configured to include a planned-use-start-time notification unit that transmits planned-use-start-time information to a first user terminal used by the first user, the planned-use-start-time information indicating the planned use start time, wherein the travel plan change recognition unit recognizes a delay of the first user with respect to the planned use start time as the change of the travel plan of the first user, and the vehicle allocation plan change unit changes the execution condition of the act of waiting by the target vehicle, the execution condition being changed based on the delay of the first user, the delay being recognized by the travel plan change recognition unit.

The vehicle allocation system described above may be configured such that the vehicle allocation plan creation unit creates the vehicle allocation plan by including allocation of the target vehicle for a second user who is other than the first user, and when the travel plan change recognition unit recognizes the delay of the first user with respect to the planned use start time, the vehicle allocation plan change unit either changes the execution condition of the act of waiting by the target vehicle or cancels the allocation of the target vehicle for the first user in the vehicle allocation plan, the execution condition being changed or the allocation being canceled based on a situation of the delay and a situation of the allocation of the target vehicle for the second user after the allocation of the target vehicle for the first user in the vehicle allocation plan.

The vehicle allocation system described above may be configured such that, when the travel plan change recognition unit recognizes the delay of the first user with respect to the planned use start time and when the allocation of the target vehicle for the second user is planned after the allocation of the target vehicle for the first user in the vehicle allocation plan, the vehicle allocation plan change unit determines whether it is possible to allocate the target vehicle for the second user according to the vehicle allocation plan provided that the target vehicle is caused to wait at the planned use start location from the planned use start time for a delay time period of the first user, and when it is not possible to allocate the target vehicle for the second user according to the vehicle allocation plan, the vehicle allocation plan change unit cancels the allocation of the target vehicle for the first user by the vehicle allocation plan.

The vehicle allocation system described above may be configured such that, when the travel plan change recognition unit recognizes the delay of the first user with respect to the planned use start time and when the allocation of the target vehicle for the second user is planned after the allocation of the target vehicle for the first user in the vehicle allocation plan, the vehicle allocation plan change unit determines whether it is possible to cause the target vehicle to arrive at the planned use start location before an extended time that is later than the planned use start time by a delay time period of the first user provided that the allocation of the target vehicle for the second user is performed first, and when it is determined that it is possible to cause the target vehicle to arrive at the planned use start location before the extended time, the vehicle allocation plan change unit changes the vehicle allocation plan such that the target vehicle is allocated for the second user first and then the target vehicle is allocated for the first user.

The vehicle allocation system described above may be configured to include a travel situation recognition unit that recognizes a travel situation of the target vehicle, wherein, when the travel situation recognition unit recognizes a delay of the target vehicle with respect to the planned use start time in arriving at the planned use start location, the vehicle allocation plan change unit transmits wait possibility inquiry information to the first user terminal, the wait possibility inquiry information inquiring whether to wait for arrival of the target vehicle even in a case where the target vehicle is delayed, and when response information indicating a response to the inquiry transmitted by the first user terminal is received, the vehicle allocation plan change unit changes the vehicle allocation plan according to the response indicated by the response information.

The vehicle allocation system described above may be configured such that, when the first user does not start using the target vehicle within a first predefined time period from the planned use start time, the target vehicle having arrived at the planned use start location due to the processing executed by the vehicle allocation processing unit according to the vehicle allocation plan, and when no delay notification information providing a notification of a delay of the first user is received from the first user terminal, the vehicle allocation plan change unit cancels the allocation of the target vehicle for the first user in the vehicle allocation plan.

The vehicle allocation system described above may be configured such that, when it is difficult to achieve travel, by using the target vehicle, within a limited time period according to the travel plan of the first user, the vehicle allocation plan change unit transmits alternative means of transportation information to the first user terminal, the alternative other means of transportation information providing guidance on use of means of transportation other than the target vehicle.

The vehicle allocation system described above may be configured such that, when the vehicle allocation plan change unit cancels the allocation of the target vehicle for the first user in the vehicle allocation plan, the vehicle allocation plan change unit transmits alternative means of transportation information to the first user terminal, the alternative means of transportation information providing guidance on use of means of transportation other than the target vehicle.

The vehicle allocation system described above may be configured to include a user evaluation unit that evaluates the first user, the first user being evaluated based on a use situation of the vehicle allocation service by the first user, wherein the vehicle allocation plan change unit changes the execution condition of the act of waiting by the target vehicle, the execution condition being changed based on a result of evaluation of the first user by the user evaluation unit.

The vehicle allocation system described above may be configured such that the user evaluation unit evaluates the first user, the first user being evaluated based on a frequency of delays of the first user with respect to the planned use start time or a frequency of cancellation of allocation of the target vehicle by the first user.

The vehicle allocation system described above may be configured such that the user evaluation unit evaluates the first user, the first user being evaluated based on the frequency of delays of the first user with respect to the planned use start time, and the vehicle allocation plan creation unit creates the vehicle allocation plan by selecting for the first user an allocation vehicle as the target vehicle from among allocation vehicles to be allocated by the vehicle allocation service, the frequency of delays of the first user with respect to the planned use start time being rated by the user evaluation unit as being equal to or greater than a first predefined level, the allocation vehicle to be selected having no allocation plan for a third user after the allocation for the first user or having a time period equal to or greater than a second predefined time period available from the allocation for the first user to the allocation for the subsequent third user, the third user being other than the first user.

The vehicle allocation system described above may be configured to include a vehicle allocation use cost setting unit that sets a use cost of the vehicle allocation service higher for the first user than for a fourth user, the frequency of delays of the first user with respect to the planned use start time or the frequency of cancellation of allocation of the target vehicle by the first user being rated by the user evaluation unit as being equal to or greater than a second predefined level, the frequency of delays of the fourth user or the frequency of cancellation by the fourth user being less than the second predefined level.

In another aspect to achieve the object described above, provided is a vehicle allocation method executable by a computer, the method including: a schedule acquisition step of the computer acquiring a schedule of a first user who uses a vehicle allocation service; a vehicle allocation plan creation step of the computer recognizing a travel plan of the first user in the schedule and creating a vehicle allocation plan for a target vehicle to be allocated for the first user, the vehicle allocation plan being created based on the travel plan; a vehicle allocation processing step of the computer executing processing for allocating the target vehicle for the first user, the target vehicle being allocated based on the vehicle allocation plan; a travel plan change recognition step of the computer recognizing a change of the travel plan of the first user, the change potentially occurring between when the vehicle allocation plan is created and when the first user starts using the target vehicle; and a vehicle allocation plan change step of the computer changing the vehicle allocation plan when the change of the travel plan of the first user is recognized in the travel plan change recognition step, the vehicle allocation plan being changed based on the change of the travel plan of the first user.

In another aspect to achieve the object described above, provided is a vehicle allocation system including: a schedule acquisition unit that accesses a storage device to acquire a schedule of a first user who uses a vehicle allocation service, the storage device having stored the schedule in the storage device; a vehicle allocation plan creation unit that executes processing of recognizing a travel plan of the first user in the schedule and creating a vehicle allocation plan for a target vehicle to be allocated for the first user, the vehicle allocation plan being created based on the travel plan; a vehicle allocation processing unit that executes processing for allocating the target vehicle for the first user, the target vehicle being allocated based on the vehicle allocation plan; a travel plan change recognition unit that executes processing of recognizing a change of the travel plan of the first user, the change potentially occurring between when the vehicle allocation plan is created and when the first user starts using the target vehicle; and a vehicle allocation plan change unit that executes processing of changing the vehicle allocation plan when the travel plan change recognition unit recognizes the change of the travel plan of the first user, the vehicle allocation plan being changed based on the change of the travel plan of the first user.

### Advantageous Effects of Invention

In the vehicle allocation system described above, the vehicle allocation plan creation unit creates a vehicle allocation plan for a target vehicle to be allocated for a user who uses a vehicle allocation service on the basis of a schedule of the user, and the vehicle allocation processing unit executes the processing for allocating the target vehicle on the basis of the vehicle allocation plan. When the travel plan change recognition unit recognizes a change of a travel plan of the user, the vehicle allocation plan change unit changes the vehicle allocation plan on the basis of the change of the travel plan. When the travel plan of the user is changed after the vehicle allocation plan is created based on the action information of the user, the vehicle allocation plan is changed according to the change of the travel plan as described above; thus, the allocation of the target vehicle can be prevented from becoming useless, and the utilization rate of the target vehicle can be inhibited from decreasing. Similar operational advantages can be obtained when the vehicle allocation method is used.

### BRIEF DESCRIPTION OF DRAWINGS

FIG. 1 is a diagram for describing an aspect of allocation of a target vehicle by a vehicle allocation system.

FIG. 2 is a configuration diagram of the vehicle allocation system.

FIG. 3 is a diagram for describing a schedule of a user and a vehicle allocation plan.

FIG. 4 is a diagram for describing a price plan based on evaluation of the user.

FIG. 5 is a flowchart illustrating processing of creating and changing the vehicle allocation plan.

FIG. 6 is a flowchart illustrating processing performed when a change of a travel plan of the user is recognized.

FIG. 7 is a flowchart illustrating processing performed when arrival of the target vehicle is delayed.

FIG. 8 is a flowchart illustrating processing performed for cancellation by the user without notice.

FIG. 9 is a diagram for describing an arrival delay guidance screen for providing a notification of an arrival delay of the target vehicle and inquiring whether it is necessary to cancel the vehicle allocation.

### DESCRIPTION OF EMBODIMENTS

### 1. Aspect of Allocation of Target Vehicle by Vehicle Allocation System

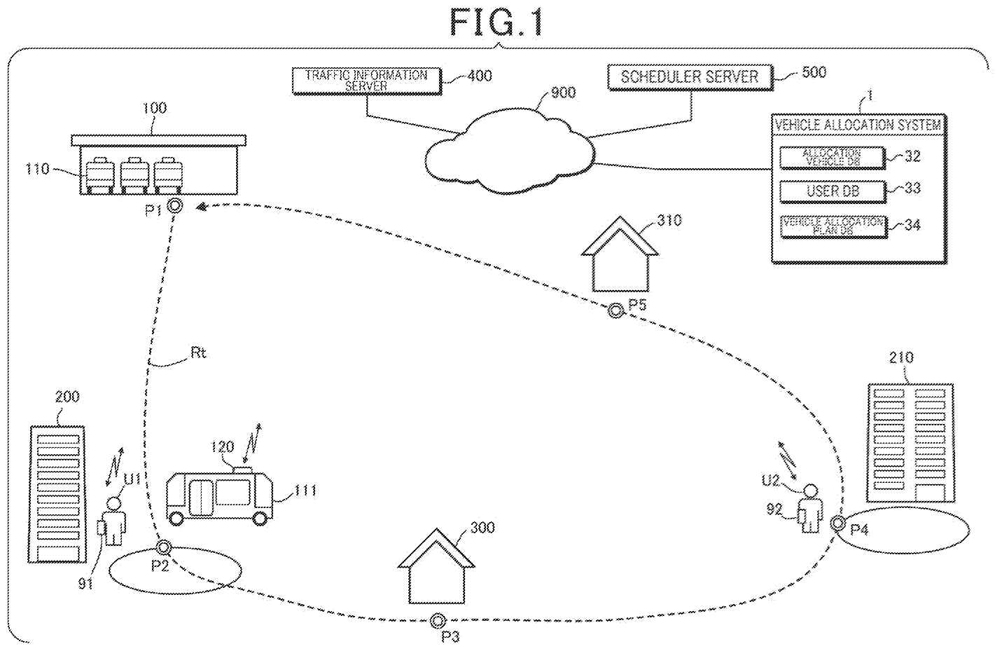

An aspect of allocation of a target vehicle by a vehicle allocation system 1 according to the present embodiment is described with reference to FIG. 1. The vehicle allocation system 1 arranges a rideshare vehicle, as means of transportation between locations, for a user who has registered with a vehicle allocation service. The vehicle allocation system 1 includes: an allocation vehicle DB (database) 32 that has stored therein information on rideshare vehicles managed by the vehicle allocation system 1; a user DB 33 that has stored therein information on a user; and a vehicle allocation plan DB 34 that has stored therein a vehicle allocation plan for a rideshare vehicle.

FIG. 1 illustrates a situation where the vehicle allocation system 1 arranges travel using a target vehicle 111 for a first user U1 from a workplace 200 of the first user U1 to a home 300 of the first user U1, and for a second user U2 from a workplace 210 of the second user U2 to a home 310 of the second user U2. The first user U1 manages a schedule of the first user U1 using a scheduler application executed by a first user terminal 91, and information on the schedule of the first user U1 is uploaded by the scheduler application to a scheduler server 500 as needed. Similarly, the second user U2 manages a schedule of the second user U2 using a scheduler application executed by a second user terminal 92, and information on the schedule of the second user U2 is uploaded by the scheduler application to the scheduler server 500 as needed.

The vehicle allocation system 1 accesses the scheduler server 500 and recognizes the schedules of the first user U1 and the second user U2 to thereby recognize travel plans of the first user U1 and the second user U2. Then, the vehicle allocation system 1 creates a vehicle allocation plan for the target vehicle 111 on the basis of the travel plans of the first user U1 and the second user U2, the target vehicle 111 being selected from among rideshare vehicles 110 that are on standby at an allocation vehicle station 100. The vehicle allocation system 1 transmits vehicle allocation plan information to the target vehicle 111.

The target vehicle 111 includes a vehicle controller 120 that controls an operation of the target vehicle 111, and the vehicle controller 120 causes the target vehicle 111 to travel according to the vehicle allocation plan information received from the vehicle allocation system 1. The target vehicle 111 may be an autonomous vehicle or a vehicle that is driven by a driver operation.

In an example of FIG. 1, the target vehicle 111 travels according to the vehicle allocation plan along a route Rt, the route Rt sequentially passing from a point P1 where the allocation vehicle station 100 is located, to a point P2 where the workplace 200 of the first user U1 is located, to a point P3 where the home 300 of the first user U1 is located, to a point P4 where the workplace 210 of the second user U2 is located, to a point P5 where the home 310 of the second user U2 is located, and to the point P1 where the allocation vehicle station 100 is located. The first user U1 travels on-board the target vehicle 111 in a section from P2 to P3, and the second user U2 travels on-board the target vehicle 111 in a section from P4 to P5.

The vehicle allocation system 1 executes processing of changing the vehicle allocation plan when the travel plan of the first user U1 is changed during a time period from the creation of the vehicle allocation plan of the target vehicle 111 to the start of use of the target vehicle 111 by the first user U1 and when a delay in arrival of the target vehicle 111 is predicted. The following mainly describes this processing.

### 2. Configuration of Vehicle Allocation System

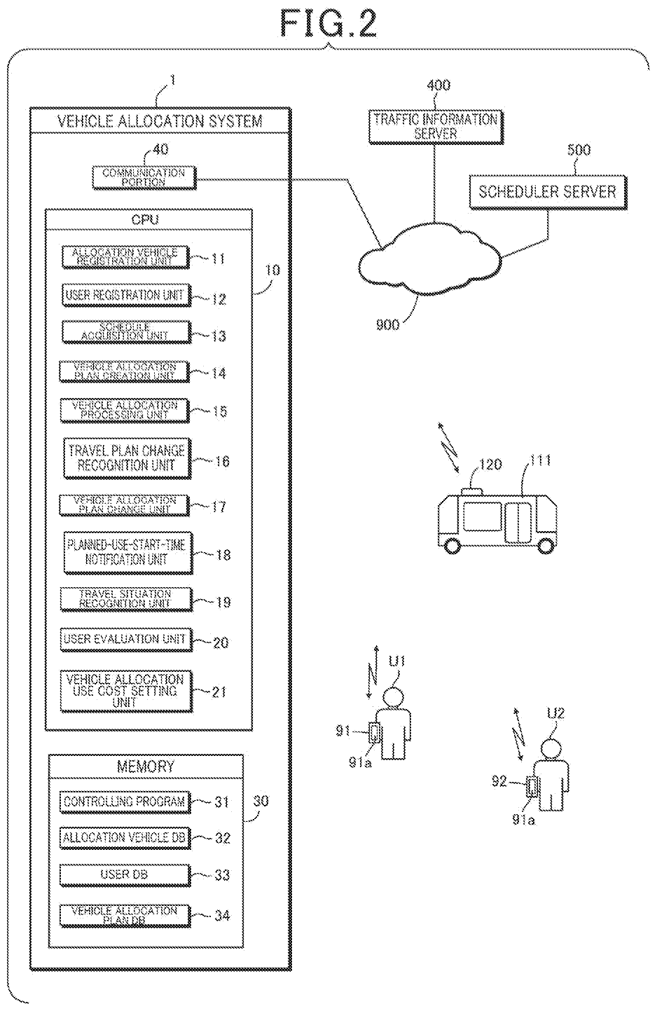

With reference to FIGS. 2 to 4, a configuration of the vehicle allocation system 1 is described below. The vehicle allocation system 1 is a computer system that configures a CPU (central processing unit) 10, a memory 30 (corresponding to a storage device of the present invention), a communication portion 40, and the like. The vehicle allocation system 1 communicates via the communication portion 40 with the first user terminal 91 used by the first user U1, the second user terminal 92 used by the second user U2, and the vehicle controller 120 of the target vehicle 111. The vehicle controller 120 may be an in-vehicle terminal provided in the target vehicle 111 or a communication terminal carried by a driver of the target vehicle 111.

The vehicle allocation system 1 also communicates via the communication portion 40 with a traffic information server 400 and the scheduler server 500. The traffic information server 400 collects information on traffic restrictions, traffic jams, weather, transportation delays, and the like and supplies the information to the vehicle allocation system 1. The scheduler server 500 supplies the information on the schedules of the first user U1 and the second user U2 to the vehicle allocation system 1, as described above.

The memory 30 has stored therein a controlling program 31 of the vehicle allocation system 1 in addition to the allocation vehicle DB 32, the user DB 33, and the vehicle allocation plan DB 34 described above. The CPU 10 reads and executes the controlling program 31 to thereby function as an allocation vehicle registration unit 11, a user registration unit 12, a schedule acquisition unit 13, a vehicle allocation plan creation unit 14, a vehicle allocation processing unit 15, a travel plan change recognition unit 16, a vehicle allocation plan change unit 17, a planned-use-start-time notification unit 18, a travel situation recognition unit 19, a user evaluation unit 20, and a vehicle allocation use cost setting unit 21.

Processing executed by the schedule acquisition unit 13 corresponds to a schedule acquisition step in a vehicle allocation method according to the present invention; processing executed by the vehicle allocation plan creation unit 14 corresponds to a vehicle allocation plan creation step in the vehicle allocation method according to the present invention; and processing executed by the vehicle allocation processing unit 15 corresponds to a vehicle allocation processing step in the vehicle allocation method according to the present invention. Processing executed by the travel plan change recognition unit 16 corresponds to a travel plan change recognition step in the vehicle allocation method according to the present invention; and processing executed by the vehicle allocation plan change unit 17 corresponds to a vehicle allocation plan change step in the vehicle allocation method according to the present invention.

A case is described below where the first user U1 registers with the vehicle allocation system 1 and uses a vehicle allocation service provided by the vehicle allocation system 1 in the aspect illustrated in FIG. 1, the vehicle allocation service allocating a rideshare vehicle. The first user U1 executes a rideshare application on the first user terminal 91, the rideshare application being provided by the vehicle allocation system 1; thus, communication between the vehicle allocation system 1 and the first user terminal 91 is enabled.

The allocation vehicle registration unit 11 records in the allocation vehicle DB 32 information (vehicle models, maintenance situations, service situations, and the like) on rideshare vehicles managed by the vehicle allocation system 1. The user registration unit 12 receives registration application information transmitted from the first user terminal 91 and records information on the first user U1 in the user DB 33. The information is recorded in the user DB 33, the information including: a user ID (identification) issued for the first user U1; the name of the first user U1; contact information; the home address; the workplace address; access information for obtaining a schedule managed by the scheduler application in use and uploaded to the scheduler server 500.

The schedule acquisition unit 13 accesses the scheduler server 500 to acquire information on the schedule of the first user U1. The vehicle allocation plan creation unit 14 recognizes a travel plan of the first user U1 on the basis of the schedule of the first user U1 acquired by the schedule acquisition unit 13. The vehicle allocation plan creation unit 14 creates a vehicle allocation plan for the target vehicle 111 on the basis of the travel plan of the first user U1.

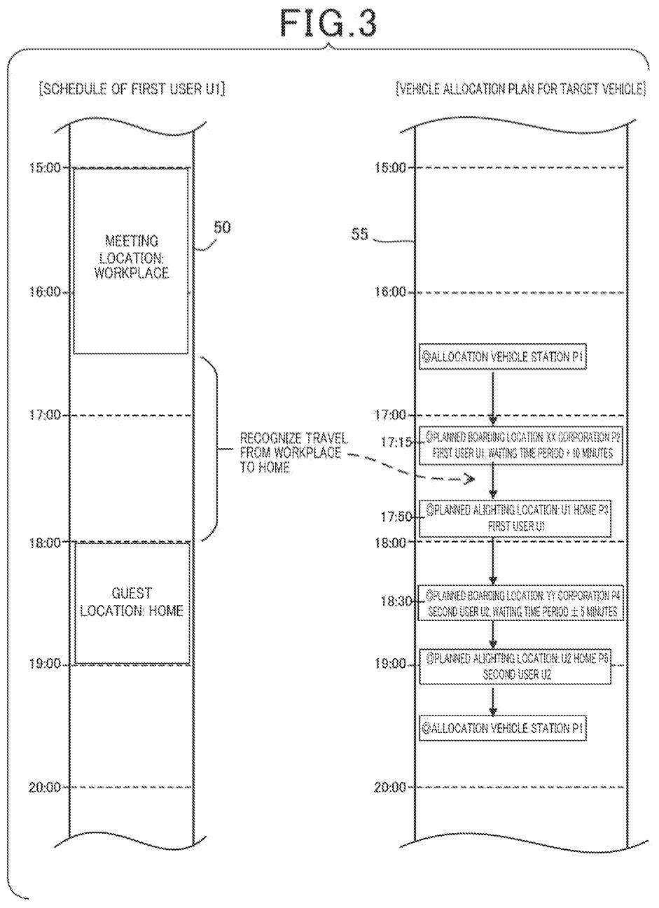

Processing performed by the vehicle allocation plan creation unit 14 is described below with reference to FIG. 3. The vehicle allocation plan creation unit 14 recognizes a schedule 50 of the first user U1 in schedule information of the first user U1 acquired by the schedule acquisition unit 13. In the schedule 50, the first user U1 plans to conduct a meeting at the workplace between 15:00 and 16:30 and meet a guest at home between 18:00 and 19:00.

The vehicle allocation plan creation unit 14 recognizes a travel plan of the first user U1 in the schedule 50 of the first user U1, the travel plan being to go home from the workplace between 16:30 and 18:00. The vehicle allocation plan creation unit 14 creates a vehicle allocation plan 55 in which the target vehicle 111 is arranged for the first user U1 to board from the workplace 200 to the home 300.

In the vehicle allocation plan 55, as boarding conditions for the first user U1, a planned boarding location (corresponding to a planned use start location in the present invention) is set to the point P2 where the workplace 200 (XX Corporation) of the first user U1 is located, and a planned boarding time is set to 17:15. As alighting conditions for the first user U1, a planned alighting location is set to the point P3 where the home 300 of the first user U1 is located, and a planned alighting time is set to 17:50. As an execution condition of an act of waiting by the target vehicle, the target vehicle 111 is set to wait for 10 minutes (+10 minutes) at the maximum from the planned boarding time (corresponding to a wait start time in the present invention), the act being for the target vehicle 111 to be caused to wait at the planned boarding location for the first user U1.

The vehicle allocation plan 55 arranges the allocation of the target vehicle 111 for the first user U1 and then for the second user U2. As boarding conditions for the second user U2, a planned boarding location is set to the point P4 where the workplace 210 (YY Corporation) of the second user U2 is located, and a planned boarding time is set to 18:30. As alighting conditions for the second user U2, a planned alighting location is set to the point P5 where the home 310 of the second user U2 is located, and a planned alighting time is set to 19:00. As an execution condition of the act of waiting by the target vehicle, the target vehicle 111 is set to wait from five minutes before the planned boarding time until five minutes after the planned boarding time (±5 minutes), the act being to be caused to wait at the planned boarding location for the second user U2. In this case, five minutes before the planned boarding time corresponds to the wait start time in the present invention.

The vehicle allocation processing unit 15 transmits information on the vehicle allocation plan, which has been created by the vehicle allocation plan creation unit 14, to the vehicle controller 120 of the target vehicle 111. The vehicle controller 120 causes the target vehicle 111 to travel according to the vehicle allocation plan and provides the first user U1 and the second user U2 with the vehicle allocation service.

The travel plan change recognition unit 16 recognizes a change of the travel plan of the first user U1, the change potentially occurring after the creation of the vehicle allocation plan. Specifically, the travel plan change recognition unit 16 recognizes a change of the travel plan of the first user U1 when the travel plan of the first user U1 acquired by the schedule acquisition unit 13 is changed and when a change to the travel plan of the first user U1 (a delay of the first user U1 with respect to the planned boarding time or the like) is notified by the first user terminal 91.

The planned-use-start-time notification unit 18 transmits planned-use-start-time notification information to the first user terminal 91, the planned-use-start-time notification information indicating the planned boarding time (a planned use start time of the first user U1 starting the use of the target vehicle 111 by boarding the target vehicle 111) set for the first user U1 in the vehicle allocation plan. The travel situation recognition unit 19 obtains traffic information by accessing the traffic information server 400 and obtains information on real-time travel situations of the target vehicle 111 from the vehicle controller 120 of the target vehicle 111, and thus recognizes travel situations of the target vehicle 111.

The user evaluation unit 20 evaluates the first user U1 on the basis of use situations of the vehicle allocation service by the first user U1. Specifically, the user evaluation unit 20 rates the first user U1 according to the frequency of the delay of the first user U1 with respect to the planned boarding time and the frequency of cancellation without notice and assigns the first user U1 to one of three ranks described below.

Rank 1: “normal user.” The number of delays in a predefined time period (one month, for example) is equal to or less than a criterion (for example, five times, the criterion corresponding to a first predefined level in the present invention).

Rank 2: “user who makes many plan changes.” The number of delays in the predefined time period exceeds the criterion.

Rank 3: “user who makes many cancellations without notice.” The number of cancellations made without notice in the predefined time period exceeds a criterion (three times, for example).

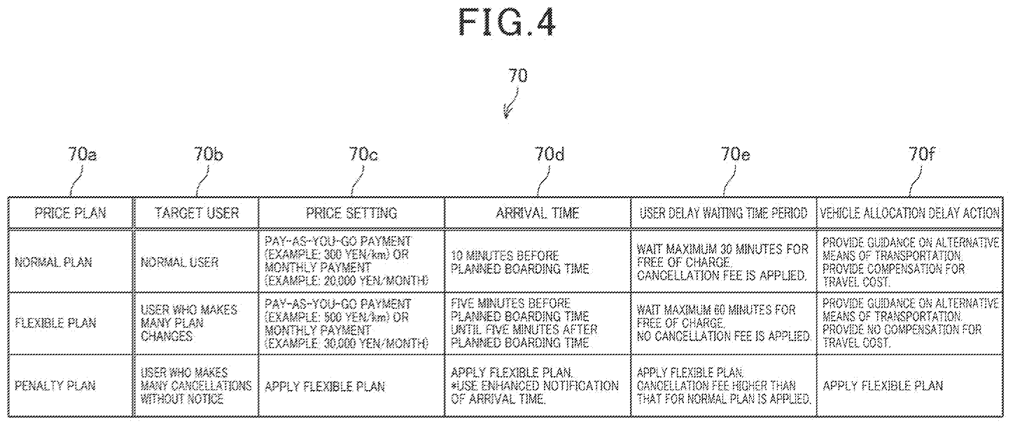

The vehicle allocation use cost setting unit 21 sets a price plan for the first user U1 on the basis of a result of evaluation by the user evaluation unit 20. The vehicle allocation use cost setting unit 21 sets a price plan for the first user U1 according to a price plan table 70 illustrated in FIG. 4. The price plan table 70 indicates conditions for a price plan name 70a, a target user 70b, price setting 70c, an arrival time 70d, a user delay waiting time period 70e, and vehicle allocation delay action 70f.

Comparison of the price setting 70c indicates that prices for a flexible plan and a penalty plan are higher than that for a normal plan. In this case, a user to whom the flexible plan and the penalty plan are applied corresponds to a fourth user in the present invention. Comparison of the arrival time 70d indicates that the normal plan assumes that a user arrives before the planned boarding time and sets the arrival time to 10 minutes before the planned boarding time. The flexible plan and the penalty plan assume that a user is not punctual and set the arrival time to five minutes before the planned boarding time until five minutes after the planned boarding time. The penalty plan also uses enhanced notification of predicted arrival time to the user. Specifically, the notification of predicted arrival time to the user is enhanced by acts such as increasing the number of times the notification of the predicted arrival time is given, by advancing notification timing, or the like.

Comparison of the user delay waiting time period 70e indicates that the normal plan assumes that the likelihood of a user being very late is low and specifies that a wait for a user delay of up to 30 minutes is free of charge and that a cancellation fee is charged for cancellation, by the user, of vehicle allocation. The flexible plan assumes that a user is likely to be late and specifies that a wait for a user delay of up to 60 minutes is free of charge and that no cancellation fee is charged for cancellation, by the user, of vehicle allocation. The penalty plan assumes that a user is likely to be late and likely to cancel and specifies that a wait for a user delay of 60 minutes at the maximum is free of charge and that a cancellation fee higher than that of the normal plan is charged for cancellation, by the user, of vehicle allocation.

A waiting time period of maximum 30 minutes and a waiting time period of maximum 60 minutes are specified with the intention that the vehicle allocation will be canceled for the user who is being late so that the vehicle may start for the subsequent planned location, even if 30 or 60 minutes have not elapsed. This is intended for a case when waiting for the user for up to 30 or 60 minutes will prevent the vehicle allocation for the subsequent planned location from being available in time.

Comparison of the vehicle allocation delay action 70f indicates that, when a delay of the vehicle allocation is predicted, the normal plan provides a user with guidance on alternative means of transportation and compensates the cost for the alternative means of transportation as an incentive for a good user. The flexible plan and the penalty plan provide a user with guidance on alternative means of transportation but do not compensate the cost for the alternative means of transportation.

### 3. Processing of Creating and Changing Vehicle Allocation Plan

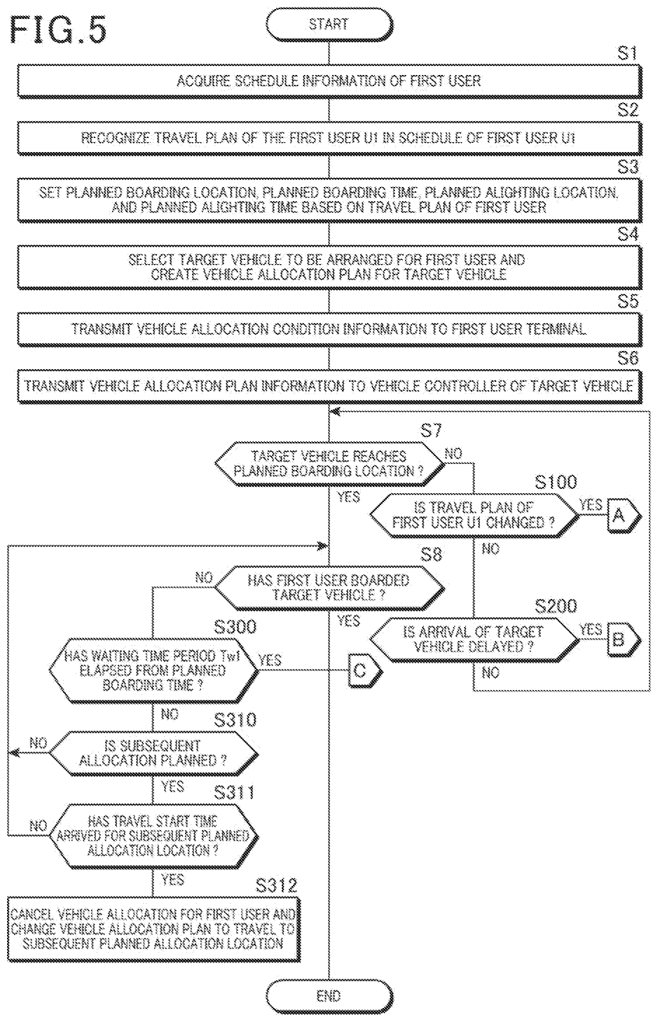

Sequential processing of creating and changing a vehicle allocation plan, performed by the vehicle allocation system 1, is described below with reference to flowcharts in FIGS. 5 to 8. The description is provided based on the example situation illustrated in FIG. 1, where the target vehicle 111 is arranged for the first user U1.

In step S1 in FIG. 5, the schedule acquisition unit 13 accesses the scheduler server 500 and acquires schedule information of the first user U1 to thereby recognize an action plan of the first user U1. In subsequent steps S2 to S4, the vehicle allocation plan creation unit 14 recognizes a travel plan of the first user U1 in the schedule of the first user U1 and sets a planned boarding location and a planned boarding time for the first user U1 to get on the target vehicle 111 and a planned alighting location and a planned alighting time for the first user U1 to get off the target vehicle 111 as described above with reference to FIG. 3. The vehicle allocation plan creation unit 14 then creates a vehicle allocation plan for the target vehicle 111, the vehicle allocation plan arranging allocation of the vehicle for the first user U1.

In subsequent step S5, the planned-use-start-time notification unit 18 transmits vehicle allocation condition information (including planned-use-start-time information in the present invention) to the first user terminal 91, the vehicle allocation condition information indicating vehicle allocation conditions set for the first user U1. The vehicle allocation conditions include vehicle information, the planned boarding location, the planned boarding time, the planned alighting location, the planned alighting time, and the like, the vehicle information including the vehicle model, the number of passengers, and occupant information. The first user U1 checks the vehicle allocation condition information received by the first user terminal 91 to thereby recognize that vehicle allocation has been arranged for the first user U1 and recognize the vehicle allocation conditions that have been arranged.

In subsequent step S6, the vehicle allocation processing unit 15 transmits the vehicle allocation plan information to the vehicle controller 120 of the target vehicle 111, the vehicle allocation plan information indicating the vehicle allocation plan. The vehicle controller 120, which has received the vehicle allocation plan information, causes the target vehicle 111 to travel along the route Rt illustrated in FIG. 1 according to the vehicle allocation plan recognized in the vehicle allocation plan information; thus, a travel service using the target vehicle 111 is provided for the first user U1.

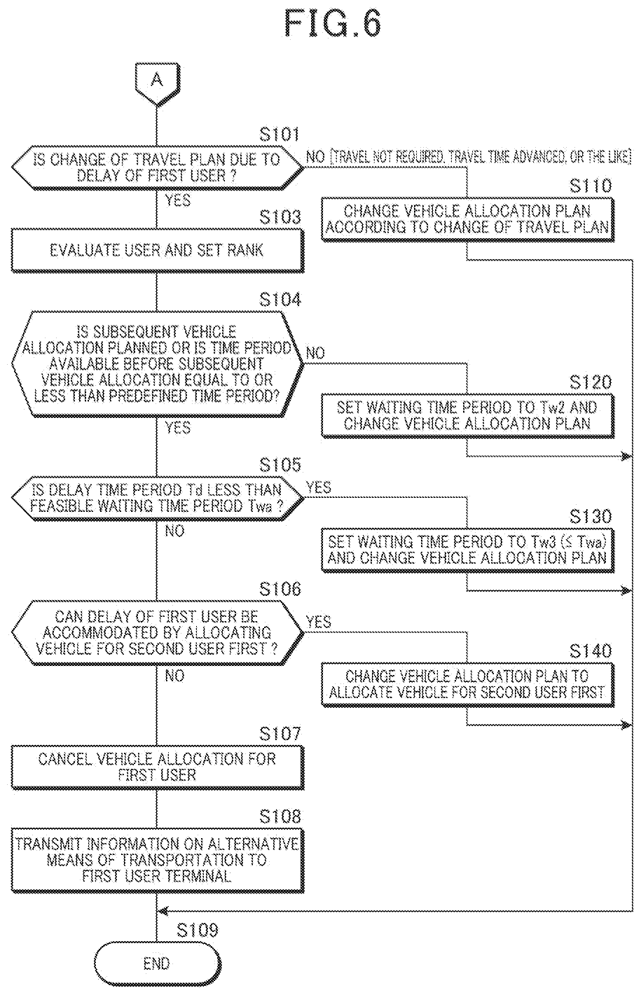

Until the travel plan change recognition unit 16 recognizes in subsequent step S7 that the target vehicle 111 has reached the planned boarding location (in this case, the planned boarding location P2 for the first user U1) from communication with the vehicle controller 120, the travel plan change recognition unit 16 determines repeatedly in step S100 whether the travel plan of the first user U1 has been changed. If it is determined that the travel plan of the first user U1 has changed, the travel plan change recognition unit 16 proceeds to step S101 in FIG. 6.

Here, the travel plan change recognition unit 16 determines that the travel plan of the first user U1 has changed in the case of (1) or (2) below.

(1) Delay notification information is received from the first user terminal 91, the delay notification information providing a notification that the first user U1 is late for the planned boarding time. In this case, the first user U1 provides a notification about the degree of delay, for example, “I will be 10 minutes late,” “I will be an hour late,” “I do not know how late I will be.”

(2) After the creation of the vehicle allocation plan, the travel plan of the first user U1 as of the creation of the vehicle allocation plan has been changed to a travel plan recognized in schedule information acquired by the schedule acquisition unit 13.

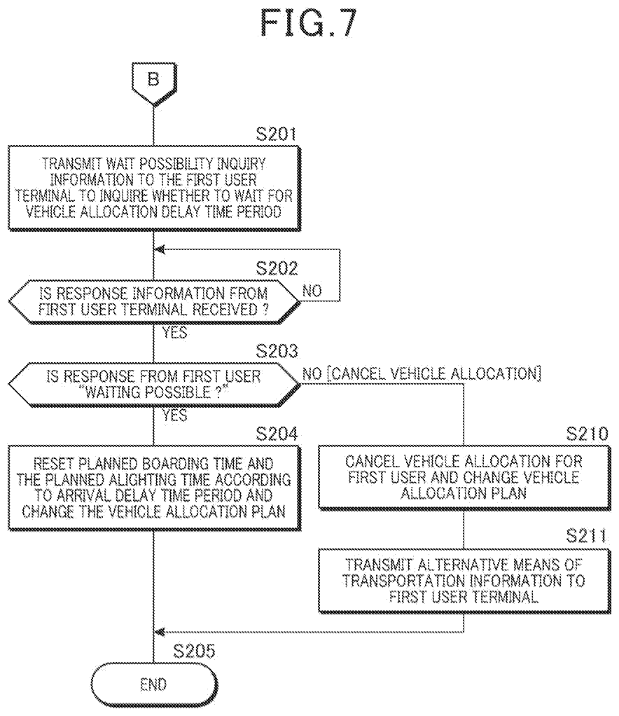

Until it is recognized in step S7 that the target vehicle 111 has reached the planned boarding location, the travel situation recognition unit 19 determines in step S200 whether a delay of the target vehicle 111 in arriving at the planned boarding location will occur. When the travel situation recognition unit 19 recognizes a delay of the arrival, the travel situation recognition unit 19 proceeds to step S201 in FIG. 7. The travel situation recognition unit 19 recognizes a delay of arrival of the target vehicle 111 on the basis of travel situations of the vehicle 111 transmitted in real time by the vehicle controller 120 of the target vehicle 111 and traffic information obtained from the traffic information server 400.

Steps S8 and S300 are processing performed when the target vehicle 111 has reached the planned boarding location P2 for the first user U1 but the first user U1 has not arrived at the planned boarding location P2 within the waiting time period. The vehicle allocation plan change unit 17 determines in step S8 whether the first user U1 has boarded the target vehicle 111 on the basis of communication with the target vehicle 111 or the first user terminal 91. If the vehicle allocation plan change unit 17 recognizes in step S8 that the first user U1 has boarded the target vehicle 111, the vehicle allocation plan change unit 17 ends the processing for a delay of the first user U1 and a delay of the target vehicle 111.

On the other hand, if it is not recognized in step S8 that the first user U1 has boarded the target vehicle 111, the vehicle allocation plan change unit 17 proceeds to step S300. In step S300, the vehicle allocation plan change unit 17 determines whether a waiting time period Tw1 (corresponding to a first predefined time period in the present invention) has elapsed from the planned boarding time. The waiting time period Tw1 is set according to the price plan table 70 illustrated in FIG. 4.

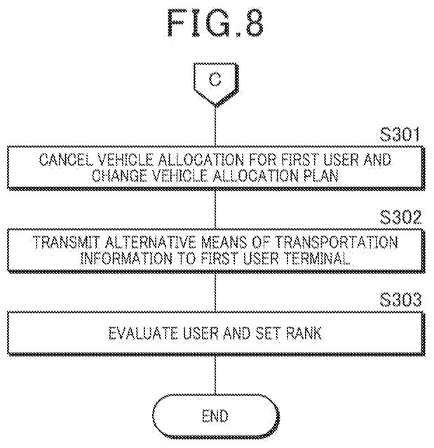

The vehicle allocation plan change unit 17 proceeds to step S301 in FIG. 8 if it is determined that the waiting time period Tw1 has elapsed from the planned boarding time, and proceeds to step S310 if it is determined that the waiting time period Tw1 has not elapsed from the planned boarding time. The vehicle allocation plan change unit 17 determines in step S310 whether subsequent allocation is planned for the vehicle. The vehicle allocation plan change unit 17 proceeds to step S311 if subsequent allocation is planned, and proceeds to step S8 if no subsequent vehicle allocation is planned.

The vehicle allocation plan change unit 17 determines in step S311 whether a travel start time has arrived for the subsequent planned allocation location. If it is determined that the travel start time has arrived for the subsequent planned allocation location, the vehicle allocation plan change unit 17 proceeds to step S312. In step S312, the vehicle allocation plan change unit 17 cancels the vehicle allocation for the first user U1 and changes the vehicle allocation plan such that the vehicle travels to the subsequent planned allocation location. In this fashion, the vehicle allocation for the first user U1 is canceled and the vehicle allocation is secured for the subsequent planned allocation location if waiting for the first user U1 until the waiting time period Tw1 elapses will prevent the vehicle allocation for the subsequent planned allocation location from being available in time. On the other hand, if it is determined that the travel start time has not arrived for the subsequent planned allocation location, the vehicle allocation plan change unit 17 proceeds from step S311 to step S8 so that the target vehicle 111 is caused to continue waiting for the first user U1.

FIG. 6 illustrates processing performed when the travel plan change recognition unit 16 recognizes a change of the travel plan of the first user. The vehicle allocation plan change unit 17 determines in step S101 whether the change of the travel plan is due to a delay of the first user U1 with respect to the planned boarding time. The vehicle allocation plan change unit 17 proceeds to step S103 if it is determined that the change of the travel plan is due to a delay of the first user U1, and proceeds to step S110 if it is determined that the change of the travel plan is not due to a delay of the first user U1.

The vehicle allocation plan change unit 17 changes in step S110 the vehicle allocation plan according to the cause for the change of the travel plan and proceeds to step S109, the cause being not a delay of the first user U1 but other causes, such as the travel being not required any longer and the travel time being advanced from the plan. On the other hand, if the cause for the change of the travel plan of the first user U1 is a delay of the first user U1, the user evaluation unit 20 sets in step S103 a rank for the first user U1.

The vehicle allocation plan change unit 17 determines in the following step S104 whether subsequent vehicle allocation is planned after the allocation for the first user U1 or whether the time period available before subsequent planned vehicle allocation is equal to or less than a predefined time period. If it is determined that subsequent vehicle allocation is planned after the allocation for the first user U1 or that the time available before subsequent planned vehicle allocation is equal to or less than the predefined time period, the vehicle allocation plan change unit 17 proceeds to step S105. On the other hand, if no subsequent vehicle allocation is planned after the first user U1 or if the time available before subsequent planned vehicle allocation is greater than the predefined time period, the vehicle allocation plan change unit 17 proceeds to step S120.

The vehicle allocation plan change unit 17 sets in step S120 the waiting time period to a waiting time period Tw2 that is longer than the waiting time period Tw1, changes the vehicle allocation plan accordingly, transmits waiting time period change information to the first user terminal 91, and proceeds to step S109, the waiting time period change information providing a notification of the waiting time period that results from the change. By extending the waiting time period when subsequent vehicle allocation is not affected, convenience can be improved for the first user U1.

The vehicle allocation plan change unit 17 determines in step S105 whether a delay time period Td of the first user U1 is less than a feasible waiting time period Twa. The feasible waiting time period Twa is set in a range that makes the subsequent vehicle allocation (the allocation for the second user U2 in the example of FIG. 1) available in time provided that the target vehicle 111 is caused to wait for an extended time period resulting from extension by the delay time period Td. The vehicle allocation plan change unit 17 proceeds to step S130 if it is determined that the delay time period Td is less than the feasible waiting time period Twa, and proceeds to step S106 if the delay time period Td is equal to or greater than the feasible waiting time period Twa.

The vehicle allocation plan change unit 17 extends in step S130 the waiting time period to a waiting time period Tw3 that is equal to or less than the feasible waiting time period Twa (≤Twa), changes the vehicle allocation plan accordingly, transmits waiting time period change information to the first user terminal 91, and proceeds to step S109, the waiting time period change information providing a notification of the waiting time period that results from the change. By extending the waiting time period in a range that causes no delay to subsequent vehicle allocation arrangement, convenience can be improved for the first user U1.

The vehicle allocation plan change unit 17 determines in step S106 whether the delay of the first user U1 can be accommodated provided that the vehicle is allocated for the second user U2 before the first user U1. Specifically, when a delay of the first user U1 is predicted, the vehicle allocation plan change unit 17 determines that the delay of the first user U1 can be accommodated if the target vehicle 111 can finish the allocation for the second user U2 and then reach the planned boarding location P2 for the first user U1 before an extended time that is later than the planned boarding time of the first user U1 by the delay time period.

The vehicle allocation plan change unit 17 proceeds to step S140 if it is determined that the delay of the first user U1 can be accommodated, and proceeds to step S107 if it is determined that the delay of the first user U1 cannot be accommodated. The vehicle allocation plan change unit 17 changes in step S140 the vehicle allocation plan such that the vehicle is allocated for the second user U2 before the first user U1, transmits predicted arrival time information to the first user terminal 91, and proceeds to step S109, the predicted arrival time information providing a notification of the predicted arrival time at the planned boarding location P2 according to the vehicle allocation plan that results from the change.

The vehicle allocation plan change unit 17 cancels in step S107 the vehicle allocation for the first user U1 and changes the vehicle allocation plan accordingly. The vehicle allocation plan change unit 17 transmits in subsequent step S108 information on alternative means of transportation to the first user terminal 91. The first user U1 can check the information on alternative means of transportation received by the first user terminal 91 and travel to the home 300 using the alternative means of transportation, such as trains and buses.

FIG. 7 illustrates processing performed when arrival of the target vehicle 111 at the planned boarding location P2 of the first user U1 is delayed. The vehicle allocation plan change unit 17 transmits in step S201 wait possibility inquiry information to the first user terminal 91, the wait possibility inquiry information inquiring whether the first user U1 will wait if a vehicle allocation delay time period occurs. If the vehicle allocation plan change unit 17 receives in subsequent step S202 response information from the first user terminal 91, the vehicle allocation plan change unit 17 proceeds to step S203.

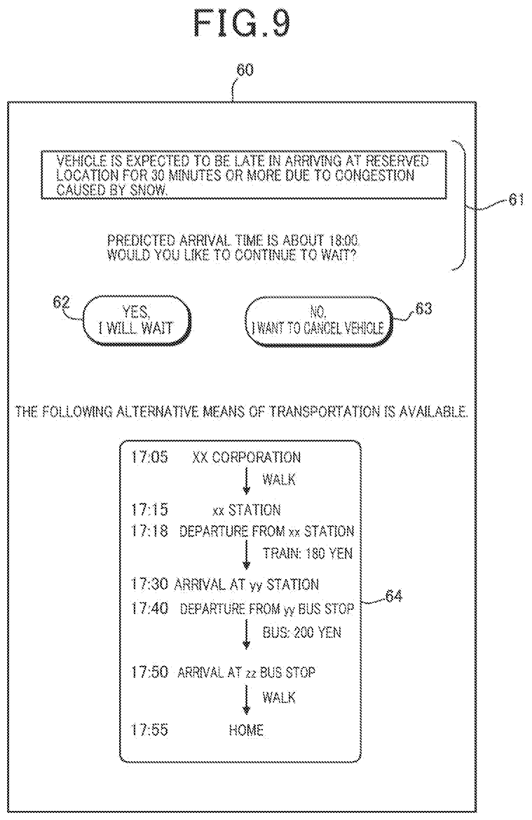

The first user terminal 91, which has received the wait possibility inquiry information, displays an arrival delay guidance screen 60, illustrated in FIG. 9, on a touch panel 91a. The arrival delay guidance screen 60 displays delay situation and predicted arrival guidance 61, a continued waiting selection button 62, a vehicle allocation cancellation selection button 63, and alternative means of transportation guidance 64.

By checking the arrival delay guidance screen 60, the first user U1 can decide whether to continue waiting for the arrival of the target vehicle 111 or to cancel the vehicle allocation and use the alternative means of transportation, with consideration given to the degree of the arrival delay and use of the alternative means of transportation. When detecting a touch operation on the continued waiting selection button 62, the first user terminal 91 transmits response information to the vehicle allocation system 1, the response information indicating a response of “waiting possible.” When detecting a touch operation on the vehicle allocation cancellation selection button 63, the first user terminal 91 transmits response information to the vehicle allocation system 1, the response information indicating a response of “cancel vehicle allocation.”

If the response from the first user U1 recognized in the response information is “waiting possible” in step S203, the vehicle allocation plan change unit 17 proceeds to step S204. On the other hand, if the response from the first user U1 recognized in the response information is not “waiting possible” (that is, “cancel vehicle allocation”), the vehicle allocation plan change unit 17 proceeds to step S210.

The vehicle allocation plan change unit 17 resets in step S204 the planned boarding time and the planned alighting time for the first user U1 according to the arrival delay time period of the target vehicle 111 and changes the vehicle allocation plan accordingly. On the other hand, the vehicle allocation plan change unit 17 cancels in step S210 the vehicle allocation for the first user U1 and changes the vehicle allocation plan accordingly. The vehicle allocation plan change unit 17 transmits in subsequent step S211 alternative means of transportation information to the first user terminal 91. The first user terminal 91, which has received the alternative means of transportation information, displays the information on the alternative means of transportation as in the arrival delay guidance screen 60 illustrated in FIG. 9 on the touch panel 91a.

FIG. 8 illustrates processing performed when the target vehicle 111 has reached the planned boarding location P2 for the first user U1 but the first user U1 has not arrived after the elapse of the waiting time period Tw1. The vehicle allocation plan change unit 17 cancels in step S301 the vehicle allocation for the first user U1 (the travel arranged from the planned boarding location P2 to the planned alighting location P3 using the target vehicle 111) and changes the vehicle allocation plan for the target vehicle 111 accordingly.

The vehicle allocation plan change unit 17 transmits in subsequent step S302 alternative means of transportation information to the first user terminal 91 as in step S211 in FIG. 7 described above. The user evaluation unit 20 evaluates in subsequent step S303 the first user U1 and sets a rank for the first user U1 as in step S103 in FIG. 6 described above.

### 4. Other Embodiments

Although the target vehicle 111, which is a rideshare vehicle, is described as the target vehicle allocated for the first user U1 and the second user U2 in the embodiment described above, the present invention is applicable to a target vehicle allocated by taxi service, car sharing, vehicle allocation services by general drivers, and the like.

Although the travel situation recognition unit 19 is provided to perform the processing for a delay of the target vehicle 111 in the embodiment described above, the travel situation recognition unit 19 may be omitted from the configuration.

In the embodiment described above, the planned-use-start-time notification unit 18 transmits in step S5 in FIG. 5 the vehicle allocation condition information of the target vehicle 111 to the first user terminal 91. In this case, information on alternative means of transportation, such as trains and buses, may be also transmitted so that the first user U1 can compare the vehicle allocation service provided by the vehicle allocation system 1 to the alternative means of transportation and make a choice. Additionally, in the vehicle allocation service provided by the vehicle allocation system 1, information on alternative means of transportation may be transmitted to the first user terminal 91 when it is difficult to achieve the travel plan recognized in the schedule of the first user U1 within the limited travel time period.

In the embodiment described above, the vehicle allocation conditions are changed based on a result of user evaluation performed by the user evaluation unit 20 as illustrated in the price plan table 70 in FIG. 4. In other embodiments in which the user evaluation is utilized, a rideshare vehicle may be allocated as the target vehicle for a third user having a frequency of delays equal to or greater than a second predefined level (the number of delays per month is equal to or greater than 5, for example), the rideshare vehicle having no subsequent allocation plan or having a time period equal to or greater than a second predefined time period available before the subsequent allocation.

Although the user evaluation unit 20 is provided and conditions for the target vehicle 111 to wait for a delay of a user are changed based on evaluation performed by the user evaluation unit 20 in the embodiment described above, the user evaluation unit 20 may be omitted from the configuration.

Although the vehicle allocation use cost setting unit 21 is provided and prices for users to pay for the use of vehicle allocation are set based on evaluation performed by the user evaluation unit 20 in the embodiment described above, the vehicle allocation use cost setting unit 21 may be omitted from the configuration.

In the embodiment described above, the vehicle allocation method according to the present invention is configured to be performed by a computer that constitutes the vehicle allocation system 1. In another configuration, a computer that constitutes the vehicle controller 120 of the target vehicle 111 may perform a method of providing information of the present invention.

In the embodiment described above, the vehicle allocation system 1 acquires schedule information of the first user U1 and the second user U2 through the scheduler server 500. Alternatively, the schedule information of the first user U1 and schedule information of the second user U2 may be acquired from the first user terminal 91 and the second user terminal 92, respectively.

Note that FIG. 2 is a schematic diagram that illustrates a functional configuration of the vehicle allocation system 1 in such a manner that divides the configuration according to main processing, in order to facilitate understanding of the invention in the present application. The configuration of the vehicle allocation system 1 may be divided differently. The processing of each constituent element may be performed by one hardware unit or a plurality of hardware units. Processing of each constituent element may be performed by one program or a plurality of programs.

### REFERENCE SIGNS LIST

1 . . . vehicle allocation system, 10 . . . CPU, 11 . . . allocation vehicle registration unit, 12 . . . user registration unit, 13 . . . schedule acquisition unit, 14 . . . vehicle allocation plan creation unit, 15 . . . vehicle allocation processing unit, 16 . . . travel plan change recognition unit, 17 . . . vehicle allocation plan change unit, 18 . . . planned-use-start-time notification unit, 19 . . . vehicle allocation situation recognition unit, 20 . . . user evaluation unit, 21 . . . vehicle allocation use cost setting unit, 30 . . . memory, 31 . . . controlling program, 32 . . . allocation vehicle DB, 33 . . . user DB, 34 . . . vehicle allocation plan DB, 40 . . . communication portion, 50 . . . action plan, 51 . . . vehicle allocation plan, 60 . . . arrival delay guidance screen, 70 . . . price plan table, 91 . . . first user terminal, 92 . . . second user terminal, 100 . . . allocation vehicle station, 110 . . . rideshare vehicle, 111 . . . target vehicle, 120 . . . vehicle controller, 400 . . . traffic information server, 500 . . . scheduler server, 900 . . . communication network

1. A vehicle allocation system comprising:
a schedule acquisition unit that acquires a schedule of a first user who uses a vehicle allocation service;
a vehicle allocation plan creation unit that recognizes a travel plan of the first user in the schedule and creates a vehicle allocation plan for a target vehicle to be allocated for the first user, the vehicle allocation plan being created based on the travel plan;
a vehicle allocation processing unit that executes processing for allocating the target vehicle for the first user, the target vehicle being allocated based on the vehicle allocation plan;
a travel plan change recognition unit that recognizes a change of the travel plan of the first user, the change potentially occurring between when the vehicle allocation plan is created and when the first user starts using the target vehicle; and
a vehicle allocation plan change unit that changes the vehicle allocation plan when the travel plan change recognition unit recognizes the change of the travel plan of the first user, the vehicle allocation plan being changed based on the change of the travel plan of the first user,
wherein the vehicle allocation plan creation unit recognizes a planned use start location and a planned use start time that are for the first user to start using the target vehicle and creates the vehicle allocation plan by including an act of waiting by the target vehicle, the planned use start location and the planned use start time being recognized based on the travel plan, the act of waiting by the target vehicle being for the target vehicle to be caused to wait at the planned use start location for a predefined waiting time period at maximum from a wait start time that is based on the planned use start time, and
the vehicle allocation plan change unit changes an execution condition of the act of waiting by the target vehicle in the vehicle allocation plan when the travel plan change recognition unit recognizes the change of the travel plan of the first user, the execution condition of the act of waiting by the target vehicle being changed based on the change of the travel plan of the first user.

2. The vehicle allocation system according to claim 1, wherein the schedule acquisition unit continues to acquire the schedule at a predefined timing after the vehicle allocation plan is created by the vehicle allocation plan creation unit, and
the travel plan change recognition unit recognizes the change of the travel plan of the first user, the change being recognized based on the schedule acquired by the schedule acquisition unit after the vehicle allocation plan is created by the vehicle allocation plan creation unit.

3. The vehicle allocation system according to claim 1, comprising a planned-use-start-time notification unit that transmits planned-use-start-time information to a first user terminal used by the first user, the planned-use-start-time information indicating the planned use start time,
wherein the travel plan change recognition unit recognizes a delay of the first user with respect to the planned use start time as the change of the travel plan of the first user, and
the vehicle allocation plan change unit changes the execution condition of the act of waiting by the target vehicle, the execution condition being changed based on the delay of the first user, the delay being recognized by the travel plan change recognition unit.

4. The vehicle allocation system according to claim 3, wherein the vehicle allocation plan creation unit creates the vehicle allocation plan by including allocation of the target vehicle for a second user who is other than the first user, and
when the travel plan change recognition unit recognizes the delay of the first user with respect to the planned use start time, the vehicle allocation plan change unit either changes the execution condition of the act of waiting by the target vehicle or cancels the allocation of the target vehicle for the first user in the vehicle allocation plan, the execution condition being changed or the allocation being canceled based on a situation of the delay and a situation of the allocation of the target vehicle for the second user after the allocation of the target vehicle for the first user in the vehicle allocation plan.

5. The vehicle allocation system according to claim 4,
wherein, when the travel plan change recognition unit recognizes the delay of the first user with respect to the planned use start time and when the allocation of the target vehicle for the second user is planned in the vehicle allocation plan after the allocation of the target vehicle for the first user, the vehicle allocation plan change unit determines whether it is possible to allocate the target vehicle for the second user according to the vehicle allocation plan provided that the target vehicle is caused to wait at the planned use start location from the planned use start time for a delay time period of the first user, and when it is not possible to allocate the target vehicle for the second user according to the vehicle allocation plan, the vehicle allocation plan change unit cancels the allocation of the target vehicle for the first user in the vehicle allocation plan.

6. The vehicle allocation system according to claim 4,
wherein, when the travel plan change recognition unit recognizes the delay of the first user with respect to the planned use start time and when the allocation of the target vehicle for the second user is planned in the vehicle allocation plan after the allocation of the target vehicle for the first user, the vehicle allocation plan change unit determines whether it is possible to cause the target vehicle to arrive at the planned use start location before an extended time that is later than the planned use start time by a delay time period of the first user provided that the allocation of the target vehicle for the second user is performed first, and
when it is determined that it is possible to cause the target vehicle to arrive at the planned use start location before the extended time, the vehicle allocation plan change unit changes the vehicle allocation plan such that the target vehicle is allocated for the second user first and then the target vehicle is allocated for the first user.

7. The vehicle allocation system according to claim 3, comprising a travel situation recognition unit that recognizes a travel situation of the target vehicle,
wherein, when the travel situation recognition unit recognizes a delay of the target vehicle with respect to the planned use start time in arriving at the planned use start location, the vehicle allocation plan change unit transmits wait possibility inquiry information to the first user terminal, the wait possibility inquiry information inquiring whether to wait for arrival of the target vehicle even in a case where the target vehicle is delayed, and when response information indicating a response to the inquiry transmitted by the first user terminal is received, the vehicle allocation plan change unit changes the vehicle allocation plan according to the response indicated by the response information.

8. The vehicle allocation system according to claim 3,
wherein, when the first user does not start using the target vehicle within a first predefined time period from the planned use start time, the target vehicle having arrived at the planned use start location due to the processing executed by the vehicle allocation processing unit according to the vehicle allocation plan, and when no delay notification information providing a notification of a delay of the first user is received from the first user terminal, the vehicle allocation plan change unit cancels the allocation of the target vehicle for the first user in the vehicle allocation plan.

9. The vehicle allocation system according to claim 3,
wherein, when it is difficult to achieve travel, by using the target vehicle, within a limited time period according to the travel plan of the first user, the vehicle allocation plan change unit transmits alternative means of transportation information to the first user terminal, the alternative means of transportation information providing guidance on use of other means of transportation other than the target vehicle.

10. The vehicle allocation system according to claim 4,
wherein, when the vehicle allocation plan change unit cancels the allocation of the target vehicle for the first user in the vehicle allocation plan, the vehicle allocation plan change unit transmits alternative means of transportation information to the first user terminal, the alternative means of transportation information providing guidance on use of means of transportation other than the target vehicle.

11. The vehicle allocation system according to claim 1, comprising a user evaluation unit that evaluates the first user, the first user being evaluated based on a use situation of the vehicle allocation service by the first user,
wherein the vehicle allocation plan change unit changes the execution condition of the act of waiting by the target vehicle, the execution condition being changed based on a result of evaluation of the first user by the user evaluation unit.

12. The vehicle allocation system according to claim 11, wherein the user evaluation unit evaluates the first user, the first user being evaluated based on a frequency of delays of the first user with respect to the planned use start time or a frequency of cancellation of allocation of the target vehicle by the first user.

13. The vehicle allocation system according to claim 12,
wherein the user evaluation unit evaluates the first user, the first user being evaluated based on the frequency of delays of the first user with respect to the planned use start time, and
the vehicle allocation plan creation unit creates the vehicle allocation plan by selecting for the first user an allocation vehicle as the target vehicle from among allocation vehicles to be allocated by the vehicle allocation service, the frequency of delays of the first user with respect to the planned use start time being rated by the user evaluation unit as being equal to or greater than a first predefined level, the allocation vehicle to be selected having no allocation plan for a third user after the allocation for the first user or having a time period equal to or greater than a second predefined time period available from the allocation for the first user to the allocation for the subsequent third user, the third user being other than the first user.

14. The vehicle allocation system according to claim 12, comprising a vehicle allocation use cost setting unit that sets a use cost of the vehicle allocation service higher for the first user than for a fourth user, the frequency of delays of the first user with respect to the planned use start time or the frequency of cancellation of allocation of the target vehicle by the first user being rated by the user evaluation unit as being equal to or greater than a second predefined level, the frequency of delays of the fourth user or the frequency of cancellation by the fourth user being less than the second predefined level.

15. A vehicle allocation method executable by a computer, the method comprising:
a schedule acquisition step of the computer acquiring a schedule of a first user who uses a vehicle allocation service;
a vehicle allocation plan creation step of the computer recognizing a travel plan of the first user in the schedule and creating a vehicle allocation plan for a target vehicle to be allocated for the first user, the vehicle allocation plan being created based on the travel plan;
a vehicle allocation processing step of the computer executing processing for allocating the target vehicle for the first user, the target vehicle being allocated based on the vehicle allocation plan;
a travel plan change recognition step of the computer recognizing a change of the travel plan of the first user, the change potentially occurring between when the vehicle allocation plan is created and when the first user starts using the target vehicle; and
a vehicle allocation plan change step of the computer changing the vehicle allocation plan when the change of the travel plan of the first user is recognized in the travel plan change recognition step, the vehicle allocation plan being changed based on the change of the travel plan of the first user,
wherein, in the vehicle allocation plan creation step, the computer recognizes a planned use start location and a planned use start time that are for the first user to start using the target vehicle and creates the vehicle allocation plan by including an act of waiting by the target vehicle, the planned use start location and the planned use start time being recognized based on the travel plan, the act of waiting by the target vehicle being for the target vehicle to be caused to wait at the planned use start location for a predefined waiting time period at maximum from a wait start time that is based on the planned use start time, and
in the vehicle allocation plan change step, the computer changes an execution condition of the act of waiting by the target vehicle in the vehicle allocation plan when the change of the travel plan of the first user is recognized by the travel plan change recognition step, the execution condition of the act of waiting by the target vehicle being changed based on the change of the travel plan of the first user.

16. A vehicle allocation system comprising:
a schedule acquisition unit that accesses a storage device to acquire a schedule of a first user who uses a vehicle allocation service, the storage device having stored the schedule in the storage device;
a vehicle allocation plan creation unit that executes processing of recognizing a travel plan of the first user in the schedule and creating a vehicle allocation plan for a target vehicle to be allocated for the first user, the vehicle allocation plan being created based on the travel plan;
a vehicle allocation processing unit that executes processing for allocating the target vehicle for the first user, the target vehicle being allocated based on the vehicle allocation plan;
a travel plan change recognition unit that executes processing of recognizing a change of the travel plan of the first user, the change potentially occurring between when the vehicle allocation plan is created and when the first user starts using the target vehicle; and
a vehicle allocation plan change unit that executes processing of changing the vehicle allocation plan when the travel plan change recognition unit recognizes the change of the travel plan of the first user, the vehicle allocation plan being changed based on the change of the travel plan of the first user,
wherein the vehicle allocation plan creation unit recognizes a planned use start location and a planned use start time that are for the first user to start using the target vehicle and creates the vehicle allocation plan by including an act of waiting by the target vehicle, the planned use start location and the planned use start time being recognized based on the travel plan, the act of waiting being for the target vehicle to be caused to wait at the planned use start location for a predefined waiting time period at maximum from a wait start time that is based on the planned use start time, and
the vehicle allocation plan change unit changes an execution condition of the act of waiting by the target vehicle in the vehicle allocation plan when the travel plan change recognition unit recognizes the change of the travel plan of the first user, the execution condition of the act of waiting by the target vehicle being changed based on the change of the travel plan of the first user.

17. (canceled)
